(19) United States
(12) Patent Application Publication
(10) Pub. No.: US 2016/0263799 A1
(43) Pub. Date: Sep. 15, 2016

(54) INJECTION MOLDING SYSTEM PERFORMING MOLD CLEANING

(71) Applicant: FANUC Corporation, Yamanashi (JP)

(72) Inventor: Wataru SHIRAISHI, Yamanashi (JP)

(21) Appl. No.: 15/065,148

(22) Filed: Mar. 9, 2016

(30) Foreign Application Priority Data
Mar. 12, 2015 (JP) 2015-049616

(51) Int. Cl. B29C 45/17; B29C 45/76; B29C 45/03

(52) U.S. Cl. CPC B29C 45/1753; B29C 45/03; B29C 45/768; B29C 2945/76464; B29C 2945/76147; B29C 2945/7626; B29C 2945/76816; B29C 2945/76939

(57) ABSTRACT

Comparison and analysis between stored image data which is obtained by performing image-taking by a mold image-taking means in a state in which a mold surface is clean and stored and taken image data which is obtained by performing image-taking by the mold image-taking means are performed and a cleaning part of the mold is specified to clean the mold. Accordingly, an image of a region, in which fouling and residues of fine dust may be generated, of the mold surface can be fully taken and generation of waste in a cleaning operation can be prevented.

### BACKGROUND OF THE INVENTION

1. Field of the Invention

The present invention relates to an injection molding system, and especially relates to an injection molding system which cleans a mold.

2. Description of the Related Art

An injection molding machine heats a resin material to melt the resin material, injects the melted resin material into a mold, and then solidifies the material by cooling. Thus, the injection molding machine forms a molded article. Therefore, through repeated execution of molding, residues and carbide of the resin material which is dissolved through heating, products having a low molecular weight, and the like may attach a surface of the mold. Further, when a molded article is ejected from the mold after the molded article is formed in the mold, a burr of the molded article, a portion of a thin gate portion, and the like may be cut from the molded article to remain in the mold. If these fouling, fine dust, and the like on a surface of the mold remain in the mold, the fouling, the fine dust, and the like may influence on subsequent forming of molded articles and cause generation of defective products among molded articles. Therefore, a mold cleaning operation for cleaning a mold is regularly performed.

Japanese Patent Application Laid-Open No. 2005-131914 discloses a technique in which an image of a mold surface of a movable mold of a molding machine or a fixed mold of the molding machine is acquired, presence or absence of an abnormality of the acquired image is determined, and the image is transmitted and displayed.

Japanese Patent Application Laid-Open No. 6-143297 discloses a technique in which a camera which picks up images of a movable mold after mold opening from predetermined positions and directions is provided so as to detect presence/absence of a molded article in the mold. Then, the positional deviation amount between a result of the image pick-up and preset reference image data is calculated so as to detect presence/absence of a molded article.

Japanese Patent Application Laid-Open No. 4-226319 discloses a technique in which an image of a slit pattern formed by irradiation in a mold is picked up so as to perform abnormality determination in the mold, in a monitoring device which monitors abnormality in a mold of an injection molding machine.

Japanese Patent Application Laid-Open No. 8-136461 describes a device which monitors presence/absence of a molded article and defective molding in a movable mold of an injection molding machine. Further, a camera which moves along with movement of the movable mold to constantly keep a relative position is provided so as to pick up an image of a molded article holding portion of the movable mold.

Japanese Patent Application Laid-Open No. 2002-011732 discloses a technique for cleaning a mold by providing an unloader which is arranged freely movably between molds of an injection molding machine, a cleaner which is provided on the unloader, and a sensor which detects fouling of the mold.

In Japanese Patent Application Laid-Open No. 2001-334535, a brushing device for cleaning a mold is inserted between molds of an injection molding device. Further, a CCD camera moves in a direction orthogonal to a moving direction of the brushing device to enter between the molds and pick up an image of a cleaning state of the molds. When folding remains on the mold, the mold is cleaned again in accordance with the cleaning state, an image of which is picked up by the CCD camera, of the molds.

Japanese Patent Application Laid-Open No. 2-234092 discloses a technique for detecting presence/absence of residues in a mold by using an infrared camera which is disposed in a fixed state and a reflection mirror in a method for detecting residues of a mold of an injection molding machine.

In techniques of Japanese Patent Application Laid-Open No. 2005-131914, No. 6-143297, and No. 4-226319, an image picked up by the camera or the like is analyzed so as to detect presence/absence of a molded article and remarkable abnormality of a mold. However, the camera or the like is fixed on a fixed point, so that it is hard to take an image of the whole region in a cavity of the mold and there has been a case where fouling and residues of fine dust in parts, images of which cannot be taken, of a surface of the mold cannot be detected.

In the technique disclosed in Japanese Patent Application Laid-Open No. 8-136461, though the camera is moved, the camera is moved along with movement of the movable mold and relative positions of the camera and the movable mold are constantly kept identical. Therefore, especially in a case where a cavity has a complex shape, for example, there has been a case where a part an image of which cannot be taken is generated and fouling and residues of fine dust on the mold cannot be detected, in a similar manner to Japanese Patent Application Laid-Open No. 2005-131914, No. 6-143297, and No. 4-226319.

In the technique disclosed in Japanese Patent Application Laid-Open No. 2002-011732, the sensor for detecting fouling is provided on the unloader to which a brush is mounted. This sensor merely moves in a horizontal direction along with the unloader as well. The cleaning operation of the entire part is performed again even when fouling is detected as well, so that there is a case in which fouling and residues of fine dust on a mold cannot be detected. Further, the cleaning operation is performed again with respect to a part other than a fouled part as well, so that there has been a possibility of generation of waste in the operation.

In the technique disclosed in Japanese Patent Application Laid-Open No. 2001-334535, the CCD camera is interposed between the molds and an image of a cleaning state of the molds are picked up, but this CCD camera merely moves in a horizontal direction. The cleaning operation of the entire part is performed even when fouling is detected as well, so that fouling and residues of fine dust on the mold may not be able to be detected. Further, the cleaning operation is performed again with respect to a part other than a fouled part as well, so that there has been a possibility of generation of waste in the operation.

In the technique disclosed in Japanese Patent Application Laid-Open No. 2-234092, residues in the mold are confirmed by using the infrared camera and the reflection mirror. A special step for inserting the reflection mirror is required, so that a molding cycle may be elongated. Further, in a case where a cavity of the mold has a complex shape, there has been a possibility of generation of a part an image of which cannot be taken even by using the reflection mirror.

Thus, though abnormality in a mold is detected by image pick-up or the like in the prior art techniques, but it has been hard to detect fouling and residues of fine dust on a surface throughout the whole region of the mold.

### SUMMARY OF THE INVENTION

Accordingly, an object of the present invention is to provide an injection molding system which is capable of taking an image the whole region of a surface of a mold and is capable of specifying a part requiring cleaning to clean the part.

In the invention according to claim 1 of the present application, an injection molding system according to the present invention is capable of automatically cleaning a mold and includes a mold image-taking means which takes an image of a mold surface, a moving means which moves the mold image-taking means to at least one predetermined image-taking position, a mold image storage means which stores image data, which is obtained by performing image-taking by the mold image-taking means at the image-taking position in a state in which the mold surface is clean, as stored image data, a mold cleaning determination means which compares and analyzes taken image data obtained by performing image-taking by the mold image-taking means at the image-taking position and stored image data on the image-taking position so as to determine whether or not to perform cleaning of the mold, a cleaning part specifying means which specifies a cleaning part of the mold based on an analysis result of the mold cleaning determination means in a case where the mold cleaning determination means determines that cleaning of the mold is performed, and a mold cleaning means for cleaning at least a cleaning part, which is specified by the cleaning part specifying means, of the mold.

Accordingly, an image of a region, in which fouling and residues of fine dust may be generated, of the mold surface can be fully taken. Further, a cleaning part based on the analysis result is cleaned, so that generation of waste in a cleaning operation can be prevented.

The moving means may be a robot.

The moving means may further include an image-taking position coordinate acquisition means which acquires positional coordinate information of the moving means in image-taking, and a coordinate information storage means which stores positional coordinate information, which is acquired in the image-taking position coordinate acquisition means, with taken image data, and may perform comparison and analysis between taken image data and stored image data of identical positional coordinate information.

Thus, taken image data and stored image data on an identical positional , coordinate are compared and analyzed, so that comparison and analysis can be performed between a state in which the surface of the mold is clean and a current state on the identical position.

A cleaning state confirmation means which confirms a cleaning state of the mold may be further provided, the mold cleaning determination means may determine whether or not to perform mold cleaning again after mold cleaning performed by the mold cleaning means and count a number of determination times of whether or not to perform the mold cleaning again, a reference number of times which is a maximum number of repetition times of mold cleaning may be preliminarily set in the cleaning state confirmation means, and the cleaning state confirmation means may allow generation of an alarm in a case where the number of determination times is equal to or larger than the reference number of times, and make the mold cleaning means perform cleaning of a cleaning part which is specified by the cleaning part specifying means in accordance with a determination result of the mold cleaning determination means and make the mold cleaning determination means determine whether or not to perform the mold cleaning again in a case where the number of determination times is smaller than the reference number of times and the mold cleaning determination means determines that the mold cleaning is performed again.

Accordingly, the reference number of times which is the maximum number of repetition times of the mold cleaning is preliminarily set and cleaning is repeatedly performed when the number of repetition times of the mold cleaning is smaller than the reference number of times. When the number of repetition times becomes equal to or larger than the reference number of times, an alarm is generated so as to be able to notify an operator that fouling and fine dust of the mold cannot be removed by automatic cleaning.

The moving means may serve also as a molded article taking-out means which takes out a molded article after molding.

The molded article taking-out means may be mountable on the moving means.

Thus, the moving means serves also as the molded article taking-out means, so that the moving means and the molded article taking-out means are not required to be inserted between molds as the separate structures and the whole structure can be simplified.

The mold cleaning means may be mountable on the moving means.

Thus, the mold cleaning means is mountable on the moving means, so that the moving means and the mold cleaning means are not required to be inserted between molds as the separate structures and the whole structure can be simplified.

A molded article taking-out means which takes out a molded article after molding and the mold cleaning means may be mountable on the moving means, and the mold cleaning means and the molded article taking-out means may be interchangeable.

Accordingly, taking out of a molded article and mold cleaning can be performed especially in a case where molds are small in size and an operation region between the molds is narrow, for example, as well.

The mold cleaning determination means may take an image of the mold surface by the mold image-taking means in a case where physical quantity related to a molding state of an injection molding machine exceeds a preset allowable value and compare and analyze the taken image data and the stored image data so as to determine whether or not to perform cleaning of the mold.

Accordingly, cleaning of the mold is not performed depending on the number of shots but cleaning is performed when the physical quantity related to a molding state of the injection molding machine exceeds a preset allowable value. Further, a part requiring cleaning can be found and cleaning can be preliminarily performed before the number of defective molded articles is increased and the number of times of image-taking can be reduced so as to enhance productivity of molded articles.

According to the present invention, an injection molding system which is capable of taking an image of the whole region of a mold surface and specifying a part requiring cleaning to clean the part can be provided.

### BRIEF DESCRIPTION OF THE DRAWINGS

The above-described and other objects and features of the present invention will be apparent from the following description of an embodiment in reference to the accompanying drawings. Among these drawings:

FIG. 1 is a schematic view illustrating an embodiment of the present invention;

FIG. 2 is a schematic view illustrating a state in which an image of a surface of a movable mold is taken by a video camera; and

FIG. 3 is a schematic view illustrating a state in which fouling and fine dust on the surface of the movable mold are cleaned up by an air nozzle.

### DETAILED DESCRIPTION OF THE PREFERRED EMBODIMENT

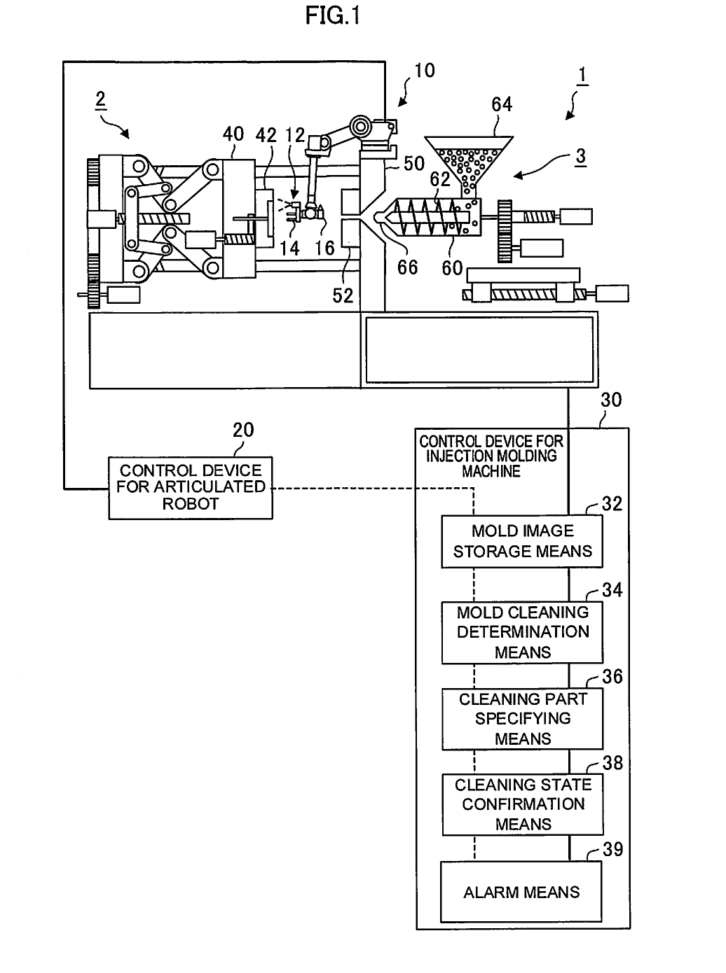

FIG. 1 is a schematic view illustrating an embodiment of the present invention. An injection molding machine 1 is mainly composed of a mold clamping device 2 and an injection device 3. The mold clamping device 2 is provided with a movable platen 40 and a fixed platen 50. Further, a movable mold 42 and a fixed mold 52 are attached to the movable platen 40 and the fixed platen 50 respectively. The injection device 3 is composed of an injection cylinder 60, a screw 62 provided in the injection cylinder 60, a hopper 64 in which a resin material to be supplied to the injection cylinder 60 is stored, and a nozzle 66 which is provided to a tip of the injection cylinder 60. Moving the movable platen performs mold closing and mold clamping and the injection device 3 presses the nozzle 66 against the fixed mold 52 to inject resin into the mold by the screw 62. Thus, a molded article is formed.

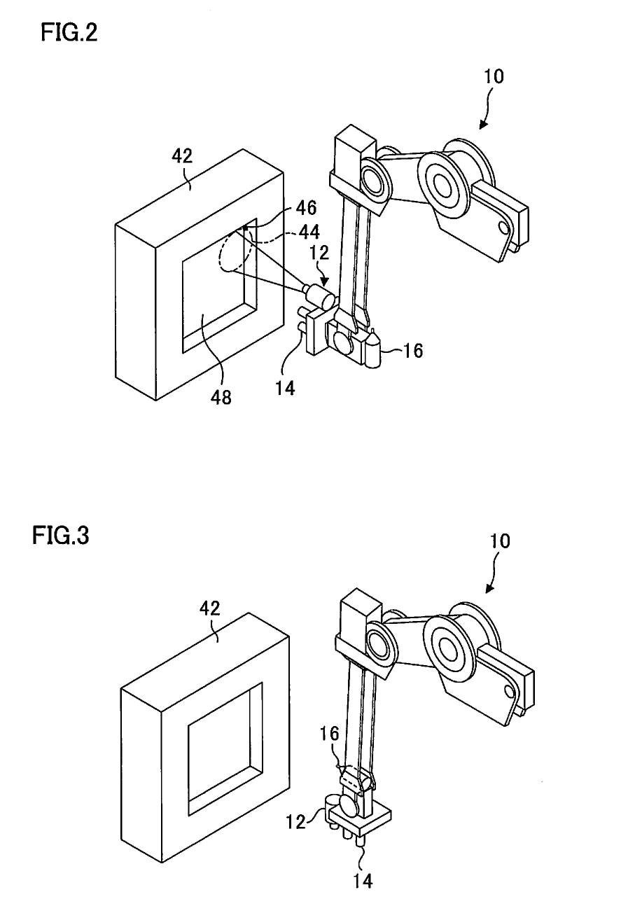

Further, an articulated robot 10 is fixed on the fixed platen 50. Furthermore, on a tip portion of the articulated robot 10, a video camera 12, a molded article gripping hand 14, and an air nozzle 16 are mounted. The tip portion of the articulated robot 10 is configured to be rotatable. The video camera 12 and the molded article gripping hand 14 can be set to be opposed to the movable mold 42 by rotating the tip portion as illustrated in FIG. 2. Further, the air nozzle 16 can be set to be opposed to the movable mold 42 as well, as illustrated in FIG. 3.

The position of the video camera 12 is moved by the articulated robot 10 and thus, the video camera 12 takes an image of a surface of the movable mold 42. FIG. 2 is a schematic view illustrating a state in which the image of the surface of the movable mold 42 is taken by the video camera 12. In the present embodiment, instead of taken the image of the entire part of the movable mold 42 by the video camera 12, partial image-taking may be repeated multiple times to acquire the whole image of the movable mold 42. An image-taking part and an image-taking angle are set for every mold depending on a shape or the like of a corresponding mold so as to be preliminarily stored in a mold image storage means 32 and image-taking is performed by the video camera 12 based on an image-taking part and an angle which are obtained by reading image-taking part information in execution of image-taking of a mold. In FIG. 2, 44 denotes an image-taking region in which image-taking is performed by the video camera 12, 46 denotes fine dust which exists in the image-taking region 44, and 48 denotes a non-image-taking region in which image-taking is not performed in the current image-taking.

The molded article gripping hand 14 takes out a molded article which is formed through mold clamping. The air nozzle 16 jets air to clean up fouling and fine dust on the surface of the movable mold 42. FIG. 3 is a schematic view illustrating a state in which fouling and fine dust on the surface of the movable mold 42 are cleaned up by the air nozzle 16. The tip portion of the articulated robot 10 is rotated from the state of FIG. 2 so as to set the air nozzle 16 to be opposed to the movable mold 42. Thus, fouling and fine dust on the surface of the movable mold 42 is cleaned up at a part requiring cleaning as illustrated later.

Further, a control device 20 for an articulated robot is provided in the articulated robot 10. A control device 30 for an injection molding machine controls the injection molding machine 1. In the control device 30 for an injection molding machine, the mold image storage means 32, a mold cleaning determination means 34, a cleaning part specifying means 36, a cleaning state confirmation means 38, and an alarm means 39 which will be described later are provided. As the mold image storage means 32, a hard disk, a memory card, or the like is used. As the alarm means 39, a lamp, a buzzer, a display device, or the like is used. Here, the fixed mold 52 can be image-taken and cleaned as is the case with the movable mold 42.

Operations of the articulated robot 10 and the like are now described. The articulated robot 10 is provided with multiple articulations to be capable of moving the tip portion thereof to an arbitrary position of the movable mold 42. The articulated robot 10 moves the tip portion thereof to be able to move the video camera 12 which is attached to the tip portion to a coordinate position and an angle desired to be image-taken. Accordingly, an image of a region, in which fouling and residues of fine dust causing defective molding may be generated, of the mold surface can be easily taken even in the complex mold structure. Here, a camera which takes still pictures can be used instead of the video camera 12.

In the mold image storage means 32, an image, which is taken on an image-taking position, of the movable mold 42 is stored. The mold cleaning determination means 34 compares an image of the movable mold 42 which is stored in the mold image storage means 32 with the image data taken by the video camera 12 on a coordinate position which is approximately identical to that of the image stored in the mold image storage means 32. When there is change larger than a threshold value on a hue, chroma, brightness, and the like, the mold cleaning determination means 34 determines that the corresponding position requires cleaning and outputs a coordinate of the position to the cleaning part specifying means 36.

When an image of the movable mold 42 is stored in the mold image storage means 32, a positional coordinate of an image-taking position is added to image data in image-taking. Accordingly, comparison and analysis are easily performed by using image data of identical image-taking positions. A coordinate can be added to image data by putting numerical values, alphabets, and the like to a file name and a property of a file. For example, when positional coordinates of “an X coordinate, a Y coordinate, a Z coordinate, a direction of a camera, and an inclination” are added, a file name to which numerical values of a positional coordinate, a direction of a camera, and an inclination are directly put such as “Img1_100-200-500-120-30.bmp”, for example, may be used. In this case, files having the same numerical value groups after an underbar are images taken on identical image-taking positions and thus, data extraction for image comparison can be easily performed. Further, positional data of respective operation axes of the articulated robot 10 may be set to the above-mentioned positional coordinates.

After the positional coordinate is outputted from the mold cleaning determination means 34 to the cleaning part specifying means 36, the cleaning part specifying means 36 moves the articulated robot 10 to a position requiring cleaning and drives the air nozzle 16 to perform cleaning. As the mold cleaning means, a brush or the like may be used instead of the air nozzle 16. In any case, when the mold cleaning means is set to be mountable on the tip portion of the articulated robot 10, the movable mold 42 can be precisely cleaned in a short period of time.

Here, in the present embodiment, the articulated robot 10 is inserted between the molds in a state in which the molds are completely opened. Other than the state in which the molds are open to a mold-opening completion position, the molds may be opened at a certain extent, that is, the extent to which the articulated robot 10, the video camera 12, and the like can be inserted between the fixed mold 52 and the movable mold 42.

The cleaning state confirmation means 38 re-determines a state after cleaning by taking the image of the surface of the movable mold 42 again by the video camera 12 after cleaning. When it is determined that the surface of the mold is clean as a result of the re-determination, the mold cleaning is ended.

When it is determined that the surface of the mold is not clean, the cleaning is performed again.

When it is determined that the surface of the mold is not clean and re-cleaning is still needed even after cleaning is performed predetermined reference times, the cleaning state confirmation means 38 outputs an alarm signal to the alarm means 39 so as to allow the alarm means 39 to generate an alarm by light, sound, display, or the like. Accordingly, it becomes possible to notify an operator that cleaning cannot be completed by automatic cleaning.

An image of a region, in which fouling and residues of fine dust causing defective molding may be generated, of the mold surface is entirely taken by multiple-time image-taking by the video camera 12 and image data of a plurality of image-taking parts which are in clean states are stored. Images are taken at a plurality of image-taking parts by the video camera 12 immediately after a step of taking out a molded article or after molding of planned number of shots, for example, and comparison and analysis are performed in the mold cleaning determination means 34 to determine whether or not to perform mold cleaning. Accordingly, it is possible to check and remove fouling and residues of fine dust on the mold surface throughout a region, in which fouling and residues of fine dust causing defective molding may be generated, of the mold surface.

The molded article gripping hand 14 is provided to the articulated robot 10, so that taking out of a molded article and taking of the image of the mold surface can be performed by a single articulated robot 10. Further, the video camera 12 is also provided to the articulated robot 10, so that image-taking can be performed immediately after taking out a molded article by a single articulated robot 10 in a case where an image of a mold surface is taken in every shot. Accordingly, taking out of a molded article and image-taking can be performed in minimum required time and thus, unwanted elongation of cycle time can be prevented.

Further, the air nozzle 16 for cleaning a mold is also mounted on the articulated robot 10, so that taking out of a molded article, taking of the image of the mold surface, and cleaning of the mold can be performed by a single articulated robot 10.

In the present embodiment, all of the video camera 12, the molded article gripping hand 14, and the air nozzle 16 are mounted on the tip portion of the articulated robot 10. In a case where a mold is small in size and taking out of a molded article and cleaning of the mold are required to be performed in a narrow operation region, the air nozzle 16 and the molded article gripping hand 14 can be set mountable on the tip portion of the articulated robot 10 in an interchangeable manner. Accordingly, the molded article gripping hand 14 can be mounted in normal molding and be exchanged for the air nozzle 16 only in mold cleaning for performing cleaning. Such configuration enables taking out of a molded article and performing of mold cleaning even in a case where molds are small in size, an operation region between the molds is narrow, and insertion between the molds is difficult when both of the air nozzle 16 and the molded article gripping hand 14 are mounted.

The image of the mold does not have to be taken in every shot or when the number of shots reaches the preset number of shots. Image-taking may be performed when physical quantity data which is measured and recorded by the injection molding machine and related to a molding state such as measuring time, injection time, injection pressure, a load on a mold opening-closing driving device, a load on an ejector driving device exceeds a preset allowable value. In such setting of the image-taking interval, image-taking is performed when the above-mentioned physical quantity data exceeds the allowable value so as to determine whether mold cleaning is needed or not. Accordingly, a part requiring cleaning can be found and cleaning can be preliminarily performed before the number of defective molded articles is increased. In a case where a mold with a low frequency of cleaning is used, the number of times of image-taking can be reduced compared to a case where image-taking is performed for every shot or when the number of shots reaches the preset number of shots. Thus, productivity of molded articles can be enhanced and timing of mold cleaning can be automatically found as need arises.

In the present embodiment, the mold image storage means 32, the mold cleaning determination means 34, the cleaning part specifying means 36, and the cleaning state confirmation means 38 are provided to the control device 30 for an injection molding machine. The mold image storage means 32, the mold cleaning determination means 34, the cleaning part specifying means 36, and the cleaning state confirmation means 38 may be provided to the control device 20 for an articulated robot, a centralized control system which is not illustrated, or the like so that both of the injection molding machine and the articulated robot operate while referring to these means. Further, in the present embodiment, the molded article gripping hand 14 is set to be mountable and is mounted on the tip portion of the articulated robot 10. However, the articulated robot 10 itself may be provided with a function of taking out a molded article.

1. An injection molding system which is capable of automatically cleaning a mold, the injection molding system comprising:
a mold image-taking means which takes an image of a mold surface;
a moving means which moves the mold image-taking means to at least one predetermined image-taking position;
a mold image storage means which stores image data, the image data being obtained by performing image-taking by the mold image-taking means at the image-taking position in a state in which the mold surface is clean, as stored image data;
a mold cleaning determination means which compares and analyzes taken image data obtained by performing image-taking by the mold image-taking means at the image-taking position and stored image data on the image-taking position so as to determine whether or not to perform cleaning of the mold;
a cleaning part specifying means which specifies a cleaning part of the mold based on an analysis result of the mold cleaning determination means in a case where the mold cleaning determination means determines that cleaning of the mold is performed; and
a mold cleaning means for cleaning at least a cleaning part of the mold, the cleaning part being specified by the cleaning part specifying means.

2. The injection molding system according to claim 1, wherein the moving means is a robot.

3. The injection molding system according to claim 1, wherein
the moving means further includes
an image-taking position coordinate acquisition means which acquires positional coordinate information of the moving means in image-taking, and
a coordinate information storage means which stores positional coordinate information, the positional coordinate information being acquired in the image-taking position coordinate acquisition means, with taken image data, and
performs comparison and analysis between taken image data and stored image data of identical positional coordinate information.

4. The injection molding system according to claim 1, further comprising:
a cleaning state confirmation means which confirms a cleaning state of the mold, wherein
the mold cleaning determination means determines whether or not to perform mold cleaning again after mold cleaning performed by the mold cleaning means and counts a number of determination times of whether or not to perform the mold cleaning again,
a reference number of times, the reference number being a maximum number of repetition times of mold cleaning, is preliminarily set in the cleaning state confirmation means, and
the cleaning state confirmation means
allows generation of an alarm in a case where the number of determination times is equal to or larger than the reference number of times, and
makes the mold cleaning means perform cleaning of a cleaning part which is specified by the cleaning part specifying means in accordance with a determination result of the mold cleaning determination means and makes the mold cleaning determination means determine whether or not to perform the mold cleaning again in a case where the number of determination times is smaller than the reference number of times and the mold cleaning determination means determines that the mold cleaning is performed again.

5. The injection molding system according to claim 1, wherein the moving means serves also as a molded article taking-out means which takes out a molded article after molding.

6. The injection molding system according to claim 5, wherein the molded article taking-out means is mountable on the moving means.

7. The injection molding system according to claim 1, wherein the mold cleaning means is mountable on the moving means.

8. The injection molding system according to claim 1, wherein
a molded article taking-out means which takes out a molded article after molding and the mold cleaning means are mountable on the moving means, and
the mold cleaning means and the molded article taking-out means are interchangeable.

9. The injection molding system according to claim 1, wherein the mold cleaning determination means takes an image of the mold surface by the mold image-taking means in a case where physical quantity related to a molding state of an injection molding machine exceeds a preset allowable value and compares and analyzes the taken image data and the stored image data so as to determine whether or not to perform cleaning of the mold.
